(19) United States
(12) Patent Application Publication
(10) Pub. No.: US 2021/0160220 A1
(43) Pub. Date: May 27, 2021

(54) SECURITY SERVICE

(71) Applicant: Microsoft Technology Licensing, LLC, Redmond, WA (US)

(72) Inventors: Nir Mardiks Rappaport, Bellevue, WA (US); Alexander Esibov, Seattle, WA (US)

(73) Assignee: Microsoft Technology Licensing, LLC, Redmond, WA (US)

(21) Appl. No.: 16/694,157

(22) Filed: Nov. 25, 2019

(51) Int. Cl. H04L 29/06

(52) U.S. Cl. CPC H04L 63/0281; H04L 63/20

(57) ABSTRACT

A security service to verify a network resource accessed from a resource address in an application at client device is disclosed. The resource address is converted into a proxy address with a suffix domain of a proxy server. The proxy server is coupled to the client device. The network resource is verified at the proxy server.

### BACKGROUND

Cloud computing is a model of service delivery for enabling convenient, on-demand network access to a shared pool of configurable computing resources that can be rapidly generated and released with nominal management effort or interaction with a provider of the service. Cloud computing allows a cloud consumer to obtain computing resources, such as networks, network bandwidth, servers, processing memory, storage, applications, virtual machines, and services as a service on an elastic and sometimes impermanent basis. Cloud computing platforms and infrastructures allow developers to build, deploy, and manage assets and resources for applications. Cloud computing may include security services that can protect resource and assets from attack.

### SUMMARY

This summary is provided to introduce a selection of concepts in a simplified form that are further described below in the Description. This summary is not intended to identify key features or essential features of the claimed subject matter, nor is it intended to be used to limit the scope of the claimed subject matter.

Computer network environments can include a security service that can enforce policies and log session data between a user device, such as a client, and a network resource such as a web application. The present disclosure is directed to a security service to verify a network resource accessed from a resource address in an application at the client device. The resource address is converted into a proxy address with a suffix domain of a proxy server. An example of a resource address for a network resource includes a web address for a web server. In one example, the suffix domain is appended on to the resource address when the resource address is accessed, such as clicked, in the application. The proxy server is coupled to the client device such as the proxy server is interposed between the client device and the network resource. The network resource is verified at the proxy server. If the security service determines the network resource is safe, the proxy server passes communication from the client device to the network resource. If, however the security service determines the network resource is unsafe, the proxy server blocks or does not pass communication from the client device to the network resource. In one example, the security service provides a warning to the client device. The security service determines whether the network resource is safe based on defined policies such as global policies and user policies.

### BRIEF DESCRIPTION OF THE DRAWINGS

The accompanying drawings are included to provide a further understanding of embodiments and are incorporated in and constitute a part of this disclosure. The drawings illustrate embodiments and together with the description serve to explain principles of embodiments. Other embodiments and many of the intended advantages of embodiments will be readily appreciated, as they become better understood by reference to the following description. The elements of the drawings are not necessarily to scale relative to each other. Like reference numerals designate corresponding similar parts.

FIG. 1 is a block diagram illustrating an example of a computing device, which can be configured in a computer network.

FIG. 2 is a schematic diagram illustrating an example computer network having a security service.

FIG. 3 is a schematic diagram illustrating an example security service in the computer network of FIG. 2.

FIG. 4 is a block diagram illustrating an example method of the security service of FIG. 3.

### DESCRIPTION

In the following Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following description, therefore, is not to be taken in a limiting sense. It is to be understood that features of the various example embodiments described herein may be combined, in part or whole, with each other, unless specifically noted otherwise.

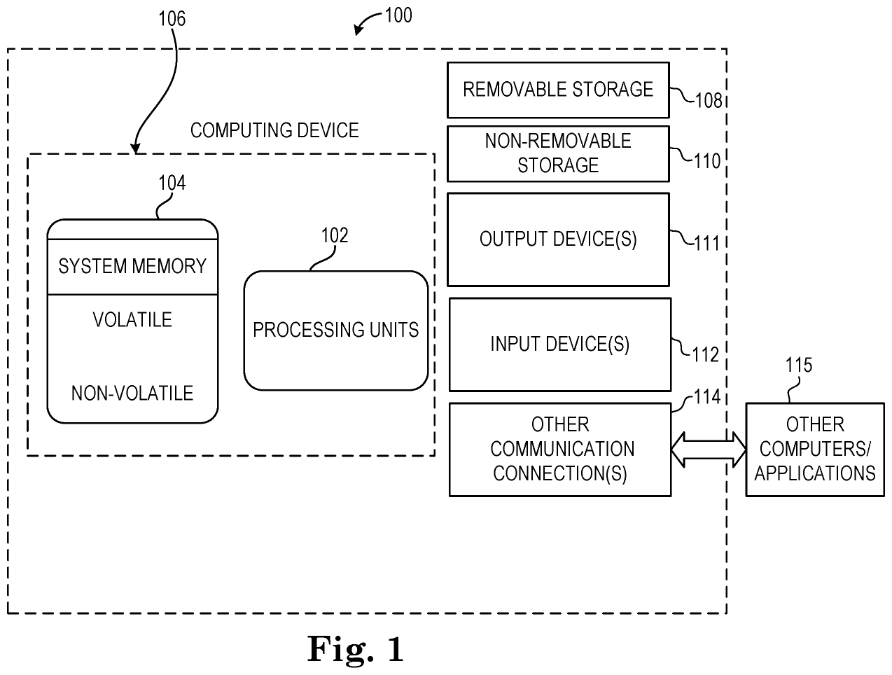

FIG. 1 illustrates an exemplary computer system that can be employed in an operating environment and used to host or run a computer application included on one or more computer readable storage mediums storing computer executable instructions for controlling the computer system, such as a computing device, to perform a process. The exemplary computer system includes a computing device, such as computing device 100. The computing device 100 can take one or more of several forms. Such forms include a tablet, a personal computer, a workstation, a server, a handheld device, a consumer electronic device (such as a video game console or a digital video recorder), or other, and can be a stand-alone device or configured as part of a computer network.

In a basic hardware configuration, computing device 100 typically includes a processor system having one or more processing units, i.e., processors 102, and memory 104. By way of example, the processing units may include two or more processing cores on a chip or two or more processor chips. In some examples, the computing device can also have one or more additional processing or specialized processors (not shown), such as a graphics processor for general-purpose computing on graphics processor units, to perform processing functions offloaded from the processor 102. The memory 104 may be arranged in a hierarchy and may include one or more levels of cache. Depending on the configuration and type of computing device, memory 104 may be volatile (such as random access memory (RAM)), non-volatile (such as read only memory (ROM), flash memory, etc.), or some combination of the two.

Computing device 100 can also have additional features or functionality. For example, computing device 100 may also include additional storage. Such storage may be removable or non-removable and can include magnetic or optical disks, solid-state memory, or flash storage devices such as removable storage 108 and non-removable storage 110. Computer storage media includes volatile and nonvolatile, removable and non-removable media implemented in any suitable method or technology for storage of information such as computer readable instructions, data structures, program modules or other data. Memory 104, removable storage 108 and non-removable storage 110 are all examples of computer storage media. Computer storage media includes RAM, ROM, EEPROM, flash memory or other memory technology, CD-ROM, digital versatile discs (DVD) or other optical storage, magnetic cassettes, magnetic tape, magnetic disk storage or other magnetic storage devices, universal serial bus (USB) flash drive, flash memory card, or other flash storage devices, or any other storage medium that can be used to store the desired information and that can be accessed by computing device 100. Accordingly, a propagating signal by itself does not qualify as storage media. Any such computer storage media may be part of computing device 100.

Computing device 100 often includes one or more input and/or output connections, such as USB connections, display ports, proprietary connections, and others to connect to various devices to provide inputs and outputs to the computing device. Input devices 112 may include devices such as keyboard, pointing device (e.g., mouse, track pad), stylus, voice input device, touch input device (e.g., touchscreen), or other. Output devices 111 may include devices such as a display, speakers, printer, or the like.

Computing device 100 often includes one or more communication connections 114 that allow computing device 100 to communicate with other computers/applications 115. Example communication connections can include an Ethernet interface, a wireless interface, a bus interface, a storage area network interface, and a proprietary interface. The communication connections can be used to couple the computing device 100 to a computer network, which can be classified according to a wide variety of characteristics such as topology, connection method, and scale. A network is a collection of computing devices and possibly other devices interconnected by communications channels that facilitate communications and allows sharing of resources and information among interconnected devices. Examples of computer networks include a local area network, a wide area network, the internet, or other network.

In one example, one or more of computing device 100 can be configured as a client device for a user in the network. The client device can be configured to establish a remote connection with a server on a network in a computing environment. The client device can be configured to run applications or software such as operating systems, web browsers, cloud access agents, terminal emulators, or utilities.

In one example, one or more of computing device 100 can be configured as a server in the network such as a server device. The server can be configured to establish a remote connection with the client device in a computing network or computing environment. The server can be configured to run application or software such as operating systems.

In one example, one or more of computing devices 100 can be configured as servers in a datacenter to provide distributed computing services such as cloud computing services. A data center can provide pooled resources on which customers or tenants can dynamically provision and scale applications as needed without having to add servers or additional networking. The datacenter can be configured to communicate with local computing devices such used by cloud consumers including personal computers, mobile devices, embedded systems, or other computing devices. Within the data center, computing device 100 can be configured as servers, either as stand alone devices or individual blades in a rack of one or more other server devices. One or more host processors, such as processors 102, as well as other components including memory 104 and storage 110, on each server run a host operating system that can support multiple virtual machines. A tenant may initially use one virtual machine on a server to run an application. The datacenter may activate additional virtual machines on a server or other servers when demand increases, and the datacenter may deactivate virtual machines as demand drops.

Datacenter may be an on-premises, private system that provides services to a single enterprise user or may be a publicly (or semi-publicly) accessible distributed system that provides services to multiple, possibly unrelated customers and tenants, or may be a combination of both. Further, a datacenter may be a contained within a single geographic location or may be distributed to multiple locations across the globe and provide redundancy and disaster recovery capabilities. For example, the datacenter may designate one virtual machine on a server as the primary location for a tenant's application and may activate another virtual machine on the same or another server as the secondary or back-up in case the first virtual machine or server fails.

A cloud-computing environment is generally implemented in one or more recognized models to run in one or more network-connected datacenters. A private cloud deployment model includes an infrastructure operated solely for an organization whether it is managed internally or by a third-party and whether it is hosted on premises of the organization or some remote off-premises location. An example of a private cloud includes a self-run datacenter. A public cloud deployment model includes an infrastructure made available to the general public or a large section of the public such as an industry group and run by an organization offering cloud services. A community cloud is shared by several organizations and supports a particular community of organizations with common concerns such as jurisdiction, compliance, or security. Deployment models generally include similar cloud architectures, but may include specific features addressing specific considerations such as security in shared cloud models.

Cloud-computing providers generally offer services for the cloud-computing environment as a service model provided as one or more of an infrastructure as a service, platform as a service, and other services including software as a service. Cloud-computing providers can provide services via a subscription to tenants or consumers. For example, software as a service providers offer software applications as a subscription service that are generally accessible from web browsers or other thin-client interfaces, and consumers do not load the applications on the local computing devices. Infrastructure as a service providers offer consumers the capability to provision processing, storage, networks, and other fundamental computing resources where the consumer is able to deploy and run software, which can include operating systems and applications. The consumer generally does not manage the underlying cloud infrastructure, but generally retains control over the computing platform and applications that run on the platform. Platform as a service providers offer the capability for a consumer to deploy onto the cloud infrastructure consumer-created or acquired applications created using programming languages, libraries, services, and tools supported by the provider. In some examples, the consumer does not manage or control the underlying cloud infrastructure including network, servers, operating systems, or storage, but has control over the deployed applications and possibly configuration settings for the application-hosting environment. In other examples, the provider can offer a combination of infrastructure and platform services to allow a consumer to manage or control the deployed applications as well as the underlying cloud infrastructure. Platform as a service providers can include infrastructure, such as servers, storage, and networking, and also middleware, development tools, business intelligence services, database management services, and more, and can be configured to support the features of the application lifecycle including one or more of building, testing, deploying, managing, and updating.

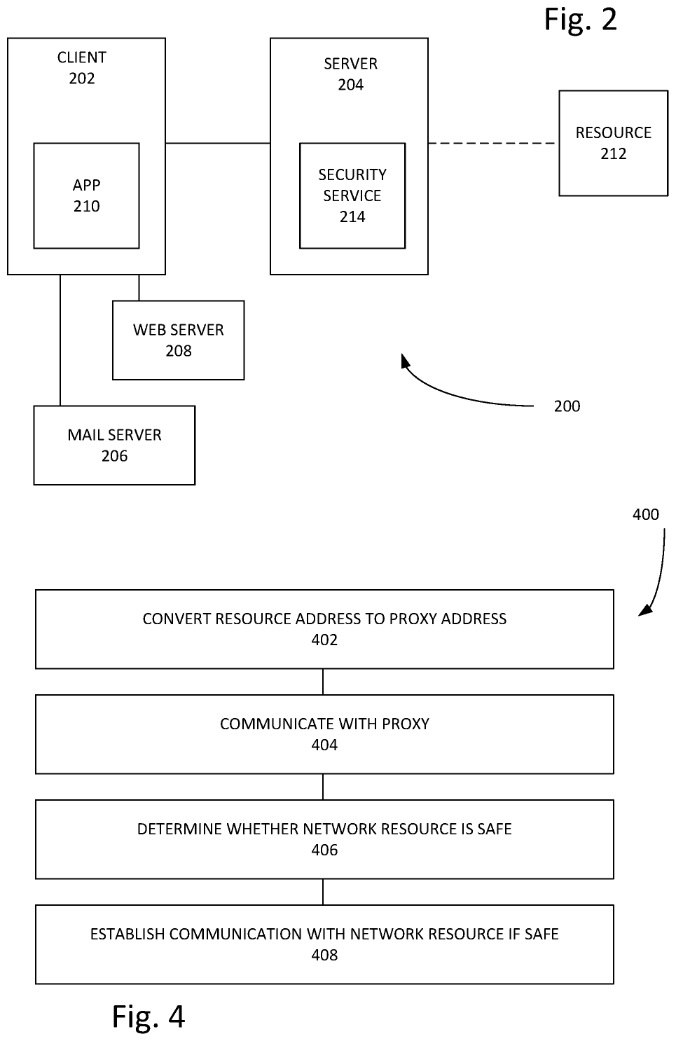

FIG. 2 illustrates an example, computer network 200 including a user device 202, such as a client device in a client-server architecture, coupled to a proxy server 204. The client device 202 can be also coupled to variety of network resources such as mail servers 206 and web servers 208 that may be accessed via the computer network 200 by the user of the user device 202. In one example, the mail server 206 may be accessed via an application 210 on the user device 202 such as a dedicated e-mail application or with a web browser, and the web server 208 may be accessed via application 210 such as a web browser or another application that can communicate with network resources 212. The mail server may provide the application 210 with messages including links to network resources 212, and attachments such as documents, files, or folders with links to network resources 212. The web server 208 can provide a web page, such as a static web page, a dynamic web page, or a web application that may be configured to run in the application 210. A web application is an example of a software application that runs on a remote server. In many cases, a web browser on the client device 202 is used to access and implement web applications over the network 200, such as the internet. The web server may also provide the application 210 with messages including links to network resources 212, and attachments such as documents, files and folders with links to network resources 212. Application 210 may also receive documents, files, or folders with links to network resource 212 from other sources such as network drives or file hosting services or via personal drives or other computing devices attached to busses or input/output connections of the user device 202. Links to network resources can include resource addressees such as web addresses or other resource identifiers that provide mechanisms for a computing device 100, such as user device 202, to access a network resource via application 210 or another application, such as a web browser.

The network 200 includes a security service 214 to provide verification of network resources 212 corresponding with resource addresses, which can include web addresses or links in the messages, attachments, documents, files, or folders that have been provided to application 210. The security service 214 is disposed to process network traffic between user device 202 and network resource 212 such as on proxy server 204. Protection and verification can be defined via policies that are provided to the security service 214 as well as additional policies defined at the security service 214. In one example, security service 214 scans the link for maliciousness and applies policies before redirecting a web browser or other application to the network resource 212. Security service 212 may be a standalone service or may be incorporated into another service such as a security broker or a cloud access security broker.

In one example, the security service 214 can be configured as a software as a service application, or SaaS, that is provided to the user device 202 on a subscription basis and is centrally hosted. An administrator may access the security service to define policies for the user device 202. The security service 214 may be based on a multitenant architecture in which a single version of the application, with a single configuration such as hardware, network, and operating system, is used for all customers, or tenants. To support scalability, the application is installed on multiple machines or horizontally scaled, in an environment such as a datacenter or multiple datacenters. For example, security service 214 can monitor user activity, warn administrators about potentially hazardous actions, enforce security policy compliance, and automatically prevent or reduce the likelihood of malware in the enterprise.

In one example, the security service 214 is a distributed, cloud-based proxy that is an inline broker for user and application activity. For selected applications 210, the security service 214 tethers itself to the application 210 through configuration changes in the application 210, and links to network resources 212 generated in the application 210 or provided to the application 210 can be directed to a proxy for verification, control and management. In one example, the security service 214 can operate as a reverse proxy at the authentication or traffic level to redirect a link through the security service 214. For instance, users are directed to web pages through the security service 214 via a reverse proxy on proxy server 204 rather than directly between the user and the web page. User requests and web application responses can travel through the security service 214 during a session. For example, the security service 214 may replace links to the network resources 212 with domains of the security service 214 to keep the user within a session. The security service 214 may append the security domains link to a link of the network resource to keep relevant links, cookies, and scripts within the session. In one example, the security service 214 can save session activities into a log and enforce policies of the session.

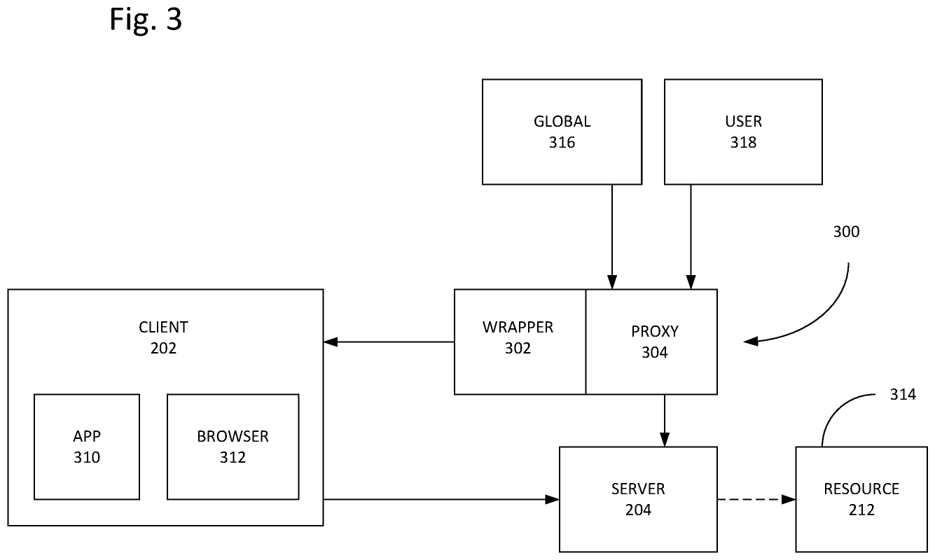

FIG. 3 illustrates a security service 300, which in one example can be incorporated into security service 214. Security service 300 includes a wrapper module 302 and a proxy 304. The security service 300 can integrate with applications on the user device 202 including application 310 that may generate accessible links to network resources 212 or receive accessible links to network resources such as from documents, files, folders, messages, and web pages. Examples of applications 310 can include e-mail programs or other communications programs, content creation programs such as word processors or file collaboration programs, web browsers, or web applications that may be configured to run in programs such as web browsers. In some examples, applications 310 can be configured to run with web browsers 312 or similar programs. For example, a content creation program or communication program may include a link to a network resource such as a web page. If a user clicks on the link in the content creation program or communication program, a web browser may be implemented to access the web page. In one example the web browser 312 may be configured to work with the application directly or through an operating system on the user device 202. The proxy 304 is interposed in the network 200 between the user device 202, including the application 310 and web browser 312 having the link to access the network resource 212 on a remote server 314.

In the example, a server 314 corresponding with the network resource 212 hosts a web address that is reference to the network resource 212, which specifies the location of a resource such as a web page on computer network such as the computer network 200. In one example, the web address of http://www.myapp.com/page/from/myapp indicates a protocol (HTTPS, or Hypertext Transfer Protocol Secure), a host name (www.myapp.com), and a file path (page/from/myapp). The web address can conform to a syntax of a generic universal resource indicator. The application 310 can receive or generate the web address as a link, and a user can click, or access, the link to initiate communication with the web server 304 that hosts a web page corresponding with the web address. In one example, communication can be established in the user device 202 such as via web browser 312. As part of communication, the server 314 can load a web page corresponding with the web address into the browser 312. In one example, the web page can be part of a web site having a set of pages indexed by the file path and included as part of a web application, such as an asynchronous web application. In one example, the web application can send and retrieve data between the user device 202 and the server 314 asynchronously without interfering generally with the display and behavior of the page in the web browser 312.

The wrapper module 302 appends a proxy suffix to the accessed resource address. In one example, the wrapper module appends the proxy suffix to the resource address to convert the resource address in the application 310 to a proxy address with a suffix domain at the time the resource address is accessed, such as the time the link is clicked. For example, the proxy suffix appended to the resource address “www.myapp.com” may include “us.securityservice.ms” and the resource address is converted to “http://www.myapp.com.us.securityservice.ms.” In this example, the web address is appended with a domain of the security service 300, or suffix domain, such as us.securityservice.ms to form the proxy address or suffix domain address. The relevant web addresses, JavaScripts, and cookies within the network resource 212 can be replaced with proxy addresses.

In one example, the wrapper module 302 is a client side feature that converts resource addresses in the application to resource addresses with appended suffix domain addresses for use with the web browser 312. The wrapper module 302 can be configured to work with various applications, including e-mail programs and content creation programs, and be included with the web browser 312 to receive the resource address provided from the application 310 or with a web application. In one example, the wrapper module 302 can be a standalone system that is run independently of the application 310 and web browser 312, or, in another example, the wrapper module can be included in the application 310 or web browser 312. The wrapper module 302 can include a computer readable storage device to store computer executable instructions to control a processor, such as the processor on the user device 202.

The appended suffix domain of the security service 300 directs the communication to the network resource 212 through the proxy 304 of the security service 300 instead of directly between user device 202 and to the web server 314. The resource address of the network resource 212 is parsed from the suffix domain at the proxy 304, and the proxy 304 verifies the network resource 212 prior to permitting communication to pass to the network resource 212. The proxy 304 may be implemented on a proxy server 204. If the security service 300 determines the network resource 212 is safe, based on policies established at the security service 300, communication is permitted to pass between the user device 202 and the network resource 212 such as through the proxy 304. If the security service 300 determines the network resource 212 is unsafe, based on policies established at the security service 300, a warning may be provided to the user device 202, such as to the web browser 312. Communication to the network resource 212 may also be blocked at the proxy 304. In some examples, the warning may include controls to pass communication to the network resource 212 and bypass the warning. If the resource address leads to an attachment, the attachment may be scanned for malware at the proxy 304.

The proxy may verify the resource address via global policies 316 and user policies 318 applied to the resource address. For example, security service 300 may include a list of network resources 212 that may be deemed unsafe, such as network resources that include malware, which can be kept in a blacklist that is applied to all tenants of the security service 300 in a global policy 316. The security service 300 may also keep a set of user policies 318 that are applicable to users of a tenant. User policies can be selected and amended by a dedicated user such as an administrator of the tenant. One user policy 318 may blacklist selected network resources to all users of the tenant. Another user policy 318 may blacklist selected resources to a selected subset of the users of the tenant. Still another user policy 318 may whitelist selected resources to all users of the tenant or another selected subset of the users of the tenant such as administrators of the tenants or another subset. The whitelist in the user policy 318 may override a blacklist in the global policy 316. In still another user policy 318, users are not permitted to bypass a warning of selected network resources. The proxy 304 can include a computer readable storage device to store computer executable instructions to control a processor, such as the processor on the proxy server 204.

FIG. 4 illustrates an example method 400 that can be used by the security service 300. The security service 300, such as via a wrapper module 302 is included with a user device 202 and tethered to an application 310 that can generate or receive a resource address corresponding with a network resource. Examples of application 310 include a desktop type application, a mobile application, and a web application that is implemented in a web browser 312. The wrapper module 302 converts the resource address to a proxy address via appending a suffix domain to the resource address at 402. In one example, the wrapper module 302 converts the resource address to the proxy address at the time the resource address is accessed, such as at the time a user clicks the resource address. The proxy address is implemented in the user device 202 to communicate with the proxy 304. In one example at 404, the accessed resource address is converted to proxy address and communication is implemented in the web browser 312 at the user device 202. Rather than access the network resource, communication is established with a proxy 304 at 404. The proxy 304 verifies the network resource 212 to determine whether the network resource 212 is safe at 406. As part of the verification at 408, the proxy 304 can apply policies to determine whether to block communication with the network resource 212. If the network resource 212 is determined to be safe at 408, communication may be established between the user device 202 and the network resource at 408. In one example, the communication may be established through the proxy 304. If the network is determined to be unsafe at 406, the proxy 304 may issue a warning to the user device 202. In some examples, the user device 202 may bypass the warning and proceed to establish communication with the network resource after communication is initially blocked. Administrators may establish policies to determine whether the network resource is safe. Additionally, the proxy 304 may log communications to the network resource 212 that administrators can download and inspect.

The example system 300 and method 400 can be implemented to include a combination of one or more hardware devices and computer programs for controlling a system, such as a computing system having a processor 102 and memory 104, to perform method 400. For instance, system 300 and method 400 can be implemented as a computer readable medium or computer readable storage device having set of executable instructions for controlling the processor 102 to perform the method 400. The system 300 and method 400 can be included as a service in a cloud environment, such as a security service implementing a cloud access security broker to enforce security polices, and implemented on a computing device 100 in a datacenter as a proxy server, such as a reverse proxy server, to direct web traffic between a user device 202 and a network resource 212.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein.

What is claimed is:

1. A method for use with an application at a client device, the method comprising:
converting a resource address accessible in the application into a proxy address with a suffix domain of a proxy server; and
verifying a network resource of the resource address at the proxy server coupled to the client device.

2. The method of claim 1 wherein the proxy server is a reverse proxy server.

3. The method of claim 1 wherein the proxy server directs traffic between the client device and the network resource.

4. The method of claim 1 wherein the proxy address is an address of a security service.

5. The method of claim 4 wherein the security service determines whether the network resource is safe.

6. The method of claim 5 wherein the security service passes communication to the network resource if the security service determines the network resource is safe.

7. The method of claim 5 wherein the security service blocks communication to the network resource if the security service determines the network resource is not safe.

8. The method of claim 5 wherein the security service issues a warning to the client device if the security service determines the network resource is not safe.

9. The method of claim 5 wherein the security service determines whether the network resource is safe based on defined policies.

10. The method of claim 9 wherein the defined policies include global policies and user policies.

11. The method of claim 1 wherein the resource address corresponds with a web server.

12. The method of claim 1 wherein the resource address is converted into the proxy address when the resource address is accessed in the application.

13. A computer readable storage device to store computer executable instructions to control a processor to:
convert a resource address accessible in an application at a client device into a proxy address with a suffix domain of a proxy server; and
verify a network resource of the resource address at the proxy server coupled to the client device.

14. The computer readable storage device of claim 14 wherein the instructions to control the processer include instructions to control the processor to determine whether the network resource is safe based on a defined policy.

15. A system, comprising:
a memory device to store a set of instructions; and
a processor to execute the set of instructions to:
convert a resource address accessible in an application at a client device into a proxy address with a suffix domain of a proxy server; and
verify a network resource of the resource address at the proxy server coupled to the client device.

16. The system of claim 15 wherein the instructions to convert and verify are implemented with a security service.

17. The system of claim 16 wherein the security service is a cloud access security broker.

18. The system of claim 17 wherein the cloud access security broker enforces security policies.

19. The system of claim 16 wherein the security service logs access of the resource address.

20. The system of claim 15 wherein the proxy server is a reverse proxy server to direct web traffic between the client device and a webserver.
